(19) United States
(12) Patent Application Publication
(10) Pub. No.: US 2008/0010118 A1
(43) Pub. Date: Jan. 10, 2008

(54) MANAGING CONTENT DOWNLOADS TO RETAIN USER ATTENTION

(75) Inventors: Gareth Alan Howell, Bothell, WA (US); Brian Duane Raffety, Edmonds, WA (US); Jeffrey C. Fong, Seattle, WA (US); Sean Jeffrey Neumann, Snohomish, WA (US); Aamer Hydrie, Seattle, WA (US); Eduardo P. Oliveira, Redmond, WA (US)

Correspondence Address: SENNIGER POWERS (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/424,207

(22) Filed: Jun. 14, 2006

(51) Int. Cl. G06Q 30/00

(52) U.S. Cl. 705/14

(57) ABSTRACT

Selecting a content item for rendering at the completion of a content item currently being rendered. The content item is selected by the user or automatically selected. The selected content item is downloaded to a computing device associated with the user such that the selected content item is available for rendering from the computing device upon completion of the content item currently being rendered.

### BACKGROUND

Consumers have been benefiting from additional freedom and control over the consumption of digital media content. One example is the proliferation of personal video recorder systems (PVRs) that allow consumers to record television shows for later viewing. The adoption of PVRs has furthered interest in on-demand, consumer-driven experiences with content consumption. Examples of existing systems include on-demand digital cable, internet video streaming services, and peer-to-peer distribution networks. Other existing systems include music and video stores providing consumers with content that may be purchased and subsequently viewed on personal video or audio players.

The existing services for consuming media content focus primarily on two revenue models: streaming of advertisement-supported content and downloading of purchased content. Streaming enables content providers to dynamically select which advertisements to display with particular content at the time of streaming. However, streaming requires network connectivity and is often plagued by poor playback quality. As such, various on-the-go scenarios cannot be enabled with streaming systems.

Further, while offering benefits to the user, existing services introduce extra complexity and break up the passive watching of television into stressful bouts of deciding which show to watch. In addition, existing services suffer from a lack of readily available content because downloading a typical show may require 20-40 minutes of download time. Existing services fail to ensure that fresh content is available for rendering to the user on demand to retain the user's viewing attention.

### SUMMARY

Embodiments of the invention improve the user experience when consuming media content. In an embodiment, the invention manages media content downloaded on a computing device. While a first content item is rendered to the user, a second content item is identified and downloaded such that the second content item is available for rendering upon completion of the rendering of the first content item. The second content item may be the next content item in a sequence of content items (e.g., the next episode) or may be identified generally as a function of user content preferences.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating a media content download system.

FIG. 2 is an exemplary flow chart illustrating operation of an application for retaining the user's viewing attention by pre-loading content for rendering.

Corresponding reference characters indicate corresponding parts throughout the drawings.

### DETAILED DESCRIPTION

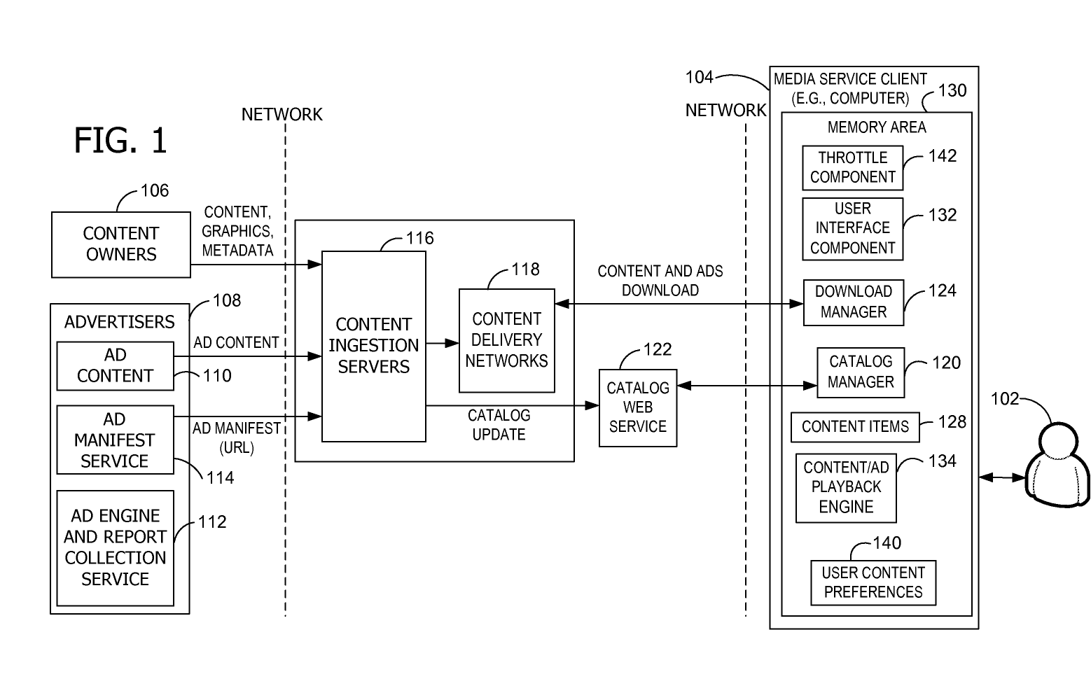

In an embodiment, the invention provides for navigation and selection of media content in a media content download service such as illustrated in FIG. 1. In addition, aspects of the invention operate to retain a user's attention by downloading and managing content on the user's computing device such that content is readily available for rendering to the user 102.

Although described primarily in the context of video media files, aspects of the invention may be applied to various forms of digital media, including video and multimedia files (e.g., movies, movie trailers, television shows, etc.), audio files (e.g., music tracks, news reports, audio web logs, audio books, speeches, comedy routines, etc.), media broadcasts (e.g., webcasts, podcasts, audiocasts, videocasts, video blogs, blogcasts, etc.), and images.

Referring again to FIG. 1, an exemplary block diagram illustrates a media content download system. In one embodiment, the media content download system of FIG. 1 is an Internet on-demand video service that offers a large catalog of program content that may be downloaded by users free of charge (e.g., no subscription fee). The program content and ads (collectively referred to as content items 128) are always available. For example, the content items 128 may be stored on a computing device local to the user 102 such as media service client 104, or archived on a server (e.g., such as owned by content owners 106). The content items 128 may be organized in a hierarchy of seasons each having series with each series having episodes. Revenue is generated by dynamically associating ads with the program content at playback time. The ads are inserted into the program content at playback time, and as such, may change from viewing to viewing.

The content owners 106 or providers supply program content (e.g., video and/or audio files) with associated metadata. This metadata includes the locations in the video at which ads can be inserted (e.g., ad breaks), and which ads provider is responsible for running the ad campaigns. For example, the ads provider may be identified by a uniform resource locator. One or more ads providers or advertisers 108 sell ads against the ad breaks. The ads providers supply ad content 110. The ads providers also run an ad engine and report collection service 112 for collecting the reports of which ads have been played. Furthermore, the ads providers make available ad manifest files via an ad manifest service 114. The ad manifests may be distributed via database, stream, file, or the like. The ad manifests include information about the current ad campaigns including which ads (or groups of ads) should be associated with which types of program content. The ad manifests also include the rules about when the advertising may be shown and on what devices/formats. The ad manifests further include the definition of tracking events for reporting on the advertising playback (e.g., a video ad was played, thus it can be billed).

Content ingestion servers 116 receive the program content supplied by the content owners 106, together with the location of the ad manifests, and publish them in a catalog. This catalog includes information about the program content and includes metadata such as categories, descriptions, duration, etc. Content delivery networks 118 interface with the media service client 104 or other computing device associated with the user 102 to deliver the content items 128 including program content and advertisements to the user 102.

The user 102 interfaces with the media service client 104, application, computing device, or the like that provides functionality such as browsing, searching, downloading, managing and consuming the content items 128. A catalog manager 120 associated with the media service client 104 downloads the catalog via, for example, a catalog web service 122 and allows the user 102 to browse it in search of content items 128. Once an item is selected for download, the corresponding ad manifest is retrieved, for example, by a download manager 124 and stored (e.g., as manifests 126). The ad manifest for each item of program content includes the information for determining which ads should be downloaded together with the program content. The download manager 124 downloads the selected program content and associated ads. Downloading includes retrieving the program content and associated ads. Downloading may also include receiving the program content and associated ads pushed from another computing device (e.g., pushed from a server at regular intervals).

The download manager 124 also periodically updates the downloaded advertisements to maintain a fresh pool of ads that may be displayed against the selected program content. Maintaining a readily available pool of ads enables offline playback, provides high-quality ad files, and allows for various different ads to be displayed against the selected program content.

For example, in one embodiment, the download manager 124 in the media service client 104 checks each of the downloaded program content items 128 to identify and parse the corresponding ad manifests to determine if the current local pool of ads is fresh. If particular ads are no longer relevant, the ads may be deleted from the local pool, while additional ads may be downloaded to keep the local ad pool fresh.

In one embodiment, one or more computer-readable media or other memory areas such as memory area 130 associated with the media service client 104 have computer-executable components comprising the catalog manager 120 for downloading a content catalog from a catalog service, a user interface component 132, the download manager 124, a playback engine 134, and a throttle component 142. The playback engine 134 renders, to the user 102, a content item (e.g., a first content item) from the content items 128 stored in the memory area 130 of the media service client 104. The throttle component 142 manages the amount of downloaded content to minimize the amount of downloaded content that has not been watched. In one embodiment, the throttle component 142 identifies another of the content items 128 (e.g., a second content item) while the first content item is being rendered by the playback engine 134. For example, content items 128 may be organized in a sequence (e.g., a series of episodes) such that the second content item immediately follows the first content item.

Prior to the downloading of the second content item, the throttle component 142 determines if the stored quantity of downloaded content items 128 has or will exceed a configurable threshold. If so, the throttle component 142 deletes one of the content items 128 before downloading an additional content item. For example, the throttle component 142 determines a quantity of the content items 128 stored in the memory area 130 and deletes one of the content items 128 as a function of the determined quantity of the content items 128. The throttle component 142 may, for example, maintain a maximum of three episodes of a series in the memory area 130. Further, the throttle component 142 manages transitory content by purging “old” content and downloading the latest content (e.g., news) to ensure that “fresh” content is available for rendering.

During the rendering of the first content item by the playback engine 134, the download manager 124 downloads the second content item identified by the throttle component 142 from the media content download service to the media service client 104. In an embodiment, the playback engine 134 renders the downloaded second content item to the user 102 upon completion of the rendering of the first content item. In another embodiment, the user interface component 132 displays metadata associated with a plurality of the content items 128 to the user 102 for selection. Responsive to the selection, the playback engine 134 renders the selected content item to the user 102.

The memory area 130 further stores user content preferences 140. The user content preferences 140 include, for example, a subscription to content such as a particular season of a particular series (e.g., each series comprising a plurality of episodes), user viewing habits, or any other preference either set by or for the user 102. In one example, the user content preferences 140 include subscriptions to a plurality of series.

The memory area 130 also stores or otherwise persists the manifests and the content items 128 (e.g., the program content and the associated advertisements) downloaded by the download manager 124. In an embodiment, the program content is divided into segments such that ad breaks may be detected. The advertisements are inserted at the ad breaks by the playback engine 134. As such, rendering of the program content is interrupted by the rendering of the advertisements. In an aspect of the invention, the manifest correlates particular ads to particular segments of the program content.

FIG. 1 shows one example of a general purpose computing device in the form of a computer. In one embodiment of the invention, a computing device such as shown in FIG. 1 is suitable for use in the other figures illustrated and described herein. The computer has one or more processors or processing units and access to a memory area such as memory area 130.

The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

In operation, a computing device executes computer-executable instructions such as those illustrated in the figures to implement aspects of the invention.

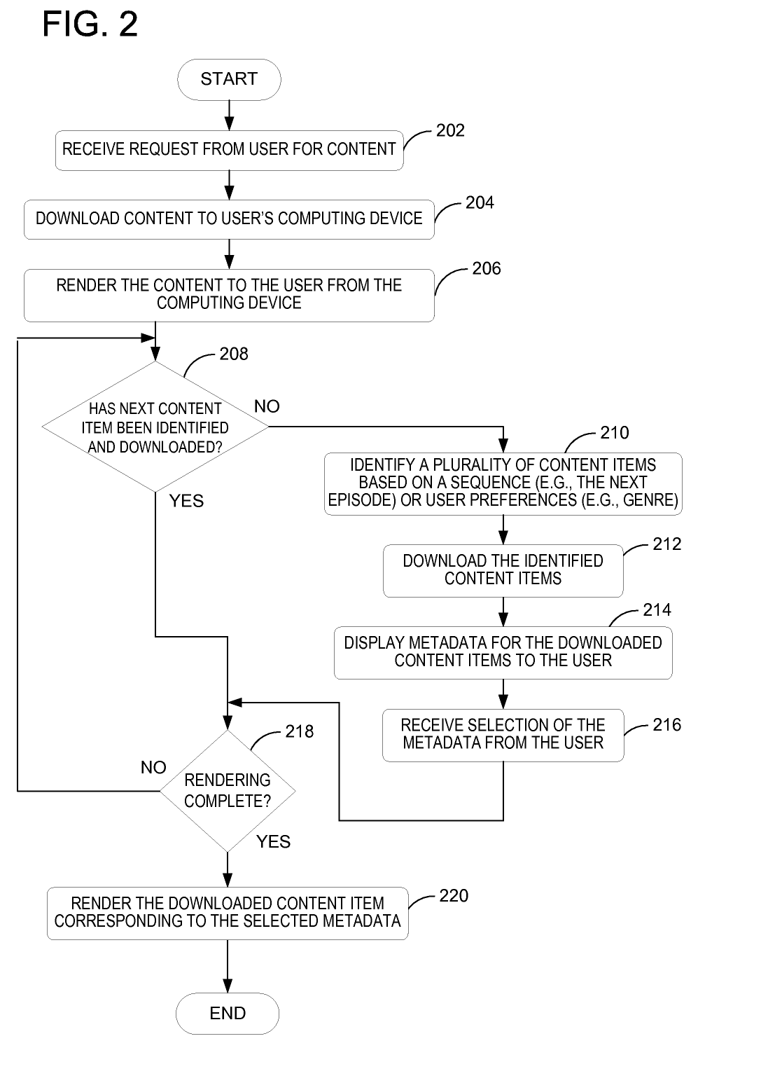

Referring next to FIG. 2, an exemplary flow chart illustrates operation of an application for retaining the user's viewing attention by pre-loading content for rendering. The application receives a request from a user such as user 102 in FIG. 1 for content at 202 (e.g., the first content item). The application downloads the requested content from the media content download service to the user's computing device at 204. In an alternative embodiment, the media content download service automatically pushes default content to the user's computing device. The default content may include trailers or samples of content available from the media content download service. In another embodiment, the default content may include the most recent episodes of a popular series, or the first season of a popular back catalog content item (e.g., canceled show).

The application renders the content to the user at 206. If the next content (e.g., the second content item) has not been identified and downloaded at 208, the application identifies a plurality of content items such as content items 128 in FIG. 1 based on a sequence associated with the content items or based on user preferences at 210. For example, the first content item may be associated with a sequence of content such as an episode in a series in a particular season. In this example, the identified plurality of content items may include the next episode in the series. As such, the second content item is next relative to the first content item in the sequence of content (e.g., the next unwatched episode in a series). Alternatively or in addition, user preferences may guide the selection of the second content item. The user preferences include, for example, identification of subscriptions for content such as a subscription for a particular season of a particular series. A subscription may identify multiple series or individual episodes. To retain the user's viewing attention, aspects of the invention may automatically renew the subscriptions in the user content preferences 140 to the next season of a series once the user finishes watching the previous season.

The user content preferences 140 may be auto-populated by the media content download service or received from the user via a user interface. In another embodiment, the second content item is randomly selected, or selected due to a genre or keyword identified by the user in the user content preferences 140. In an embodiment, the user selects the metadata without navigating away from the first content item being rendered.

The application downloads the identified content items at 212 and displays metadata associated with the downloaded content items to the user at 214. For example, two or three content items may be represented by the displayed metadata. The displayed metadata may take the form of a popup window, a dialog, an inserted advertisement, a hover window that is partially transparent, or the like. The metadata may be displayed to the user prior to the end of the current content item or at the end of the current content item to retain the user. In an embodiment, the dialog may also display a trailer for each of the displayed choices. If the content associated with all the displayed metadata has been downloaded, then the dialog may be presented prior to or at the end of the current show. If the content associated with at least one of the displayed metadata items has not been downloaded, then the dialog may appear prior to the end of the current show leaving enough time to download the remaining content.

The user selects metadata corresponding to desired content. The application receives a selection of the metadata from the user at 216 and correlates the received selection to the desired content (e.g., the second content item). If the user does not select the next content item for rendering, the next episode in the series is selected by aspects of the invention. In another embodiment, the second content item is selected without input from the user. In such an embodiment, no metadata is displayed. Instead, aspects of the invention automatically select the second content item to render to the user.

If the rendering of the first content item is complete at 218, the application renders the downloaded second content item to the user at 220. If the rendering of the first content is still in progress at 218, the application loops to 208 to confirm that the second content item has been identified and downloaded, then loops to 218 to again determine if the rendering of the first content item is complete.

In an embodiment, the first and second content items are adjacent episodes in a series. In another embodiment, the first and second content items are from different series.

In one embodiment, one or more computer-readable media have computer-executable instructions for performing the method illustrated in FIG. 2.

Although described in connection with an exemplary computing system environment, embodiments of the invention are operational with numerous other general purpose or special purpose computing system environments or configurations. The computing system environment illustrated in FIG. 1 is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, PoP devices, gaming consoles, programmable consumer electronics, mobile telephones, network PCs, minicomputers, mainframe computers, distributed computing environments that include any of the above systems or devices, and the like.

The following examples further illustrate embodiments of the invention. The figures, description, and examples herein as well as elements not specifically described herein but within the scope of aspects of the invention constitute means for retaining the viewing attention of the user at the completion of the rendering of the first content item.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

1. A method of managing media content downloaded from a media content download service, said method comprising:
rendering, via a computing device, a first content item, said first content item being part of a sequence of content items;
identifying, during said rendering, a second content item, said second content item being next relative to the first content item in the sequence of content items;
downloading, during said rendering, the identified second content item to the computing device; and
rendering, via the computing device, the downloaded second content item upon completion of the rendering of the first content item.

2. The method of claim 1, further comprising:
identifying, during said rendering of the first content item, a plurality of content items associated with the first content item;
downloading, during said rendering of the first content item, the identified plurality of content items to the computing device; and
displaying, to a user, metadata associated with each of the downloaded plurality of content items for selection by the user of one of the downloaded plurality of content items, and wherein the one of the downloaded plurality of content items selected by the user comprises the second content item.

3. The method of claim 2, wherein downloading the identified plurality of content items comprises downloading a predefined quantity of the identified plurality of content items.

4. The method of claim 2, further comprising maintaining a predefined quantity of the downloaded plurality of content items.

5. The method of 4, wherein maintaining the predefined quantity comprises deleting one of the downloaded content items prior to downloading another of the content items.

6. The method of claim 1, wherein the first content item comprises an episode in a series.

7. The method of claim 1, further comprising:
receiving a request from a user to subscribe to the first content item; and
downloading the first content item to the computing device in response to the request.

8. (canceled)

9. (canceled)

8. A system for managing media content downloaded from a media content download service, said system comprising:
a memory area for storing a plurality of content items downloaded from the media content download service, said memory area further storing user content preferences; and
a processor configured to execute computer-executable instructions for:
rendering, to the user, a first content item from the plurality of content items stored in the memory area;
identifying, during said rendering, a second content item based on the user content preferences stored in the memory area;
downloading, during said rendering, the identified second content item for storage in the memory area; and
rendering the downloaded second content item from the memory area to the user upon completion of the rendering of the first content item.

9. The system of claim 8, wherein the processor is further configured to execute computer-executable instructions for determining the user content preferences based on input from the user.

10. The system of claim 8, wherein the first content item is associated with a first series and wherein the second content item is associated with a second series.

11. The system of claim 8, wherein the user content preferences comprise a subscription to a series of content, said series comprising a plurality of episodes, wherein the user content preferences comprise user viewing habits, and wherein the user content preferences identify a plurality of series.

12. (canceled)

13. (canceled)

14. The system of claim 8, further comprising means for retaining the viewing attention of the user at the completion of the rendering of the first content item based on pre-downloading of the second content item.

15. One or more computer-readable media having computer-executable components for managing media content downloaded to a computing device from a media content download service, said components comprising:
a playback engine for rendering, to a user, a first content item from a plurality of content items stored on the computing device;
a throttle component, said throttle component:
identifying, during said rendering of the first content item by the playback engine, a second content item, said second content item being associated with the first content item;
determining a quantity of the plurality of content items stored on the computing device; and
deleting one of the plurality of content items stored on the computing device if the determined quantity of the plurality of content items exceeds a threshold quantity; and
a download manager for downloading, during said rendering of the first content item by the playback engine, the identified second content item to the computing device from the media content download service, wherein the playback engine renders the downloaded second content item upon completion of the rendering of the first content item.

16. The computer-readable media of claim 15, wherein the throttle component identifies the second content item based on user content preferences.

17. The computer-readable media of claim 16, wherein the user content preferences comprise a subscription to content.

18. The computer-readable media of claim 15, wherein the plurality of content items are organized in a sequence, and wherein the second content item follows the first content item in the sequence.

19. The computer-readable media of claim 15, wherein the throttle component deletes the one of the content items if the determined quantity of the plurality of content items is greater than two.

20. The computer-readable media of claim 15, wherein the playback engine identifies a plurality of content items, and further comprising a user interface component for displaying metadata associated with the identified plurality of content items to the user for selection of one of the plurality of content items for rendering by the playback engine.

21. The method of claim 1, wherein downloading the identified second content item includes completely downloading the identified second content item prior to completion of the rendering of the first content item.

22. The method of claim 1, wherein one or more computer-readable media have computer-executable instructions for performing the method recited in claim 1.
